(19) United States
(12) Patent Application Publication
(10) Pub. No.: US 2012/0076546 A1
(43) Pub. Date: Mar. 29, 2012

(54) MULTIPLE LOCKING FEATURE ON A CARTRIDGE DOOR

(76) Inventors: Alan E. Rapkin, Pittsford, NY (US); Donald S. Hensel, Rochester, NY (US)

(21) Appl. No.: 12/893,185

(22) Filed: Sep. 29, 2010

(51) Int. Cl. G03G 15/08

(52) U.S. Cl. 399/258; 399/260; 399/262

(57) ABSTRACT

A multiple locking feature on a cartridge door for a dry electrophotographic apparatus includes a cartridge wherein the cartridge contains a dry replenishment toner; a moveable door on the cartridge; multiple locking mechanism on the door for preventing accidental opening; and a key mechanism which unlocks the door when the cartridge is fully inserted into the electrophotographic apparatus.

### CROSS REFERENCE TO RELATED APPLICATIONS

Reference is made to commonly-assigned copending U.S. patent application Ser. No. ______ (Attorney Docket No. 96584/NAB), filed herewith, entitled METHOD FOR UNLOCKING A DOOR ON A CARTRIDGE, by Rapkin et al.; the disclosure of which is incorporated herein.

### FIELD OF THE INVENTION

The present invention relates to electrophotography in general, and more particularly to development systems used in electrophotography.

### BACKGROUND OF THE INVENTION

Electrophotographic printers and copiers form images by exposing an electrically charged toner to a pattern of charge on a surface. A toner image may be formed on a photoconductor by the sequential steps of uniformly charging the photoconductor surface in a charging station using a corona charger, exposing the charged photoconductor to a pattern of light in an exposure station to form a latent electrostatic image, and toning the latent electrostatic image by bringing the electrostatic latent image on the primary imaging member such as a photoreceptor into close proximity with a developer station. Toner particles are image-wise deposited onto the primary imaging member. The toner image may then be transferred to a receiver by pressing the receiver against the toned image bearing primary imaging member. It is generally preferred to simultaneously apply an electrostatic field to urge the toner particles to the receiver while pressing the receiver against the image-bearing primary imaging member. If desired, the image can be transferred to an intermediate transfer member and subsequently transferred to a final receiver. The toned receiver is then moved to a fusing station where the toner image is fused to the receiver by heat and/or pressure.

In electrophotographic copiers and printers, pigmented thermoplastic particles, commonly known as toner, are applied to latent electrostatic images to render such images visible. Often, the toner particles are mixed with and carried by somewhat larger particles of magnetic material. During the mixing process, the magnetic carrier particles serve to charge the toner particles to a polarity opposite that of the latent charge image. In use, the development mix is advanced, typically by magnetic forces, from a sump to a position in which it contacts the latent charge image. The relatively strong electrostatic forces associated with the charge image operate to strip the toner from the carrier, causing the toner to remain with the charge image.

In a typical development station, a housing comprises a sump that contains developer. The developer is fed to a toning roller that transports the developer into close proximity to the primary imaging member. After toning the primary imaging member, the depleted developer is stripped from the toning roller and transported back into the sump, where it is mixed with fresh developer and, if necessary, the developer is replenished with additional toner to replace the toner that had been deposited onto the primary imaging member.

The replenishment toner is introduced to the printer in a replaceable cartridge. The replacement of toner is a function performed by the customer. It is important that the unintended spillage of toner is prevented both from a cost of wasted toner and from a cleanliness perspective. The issue regarding cleanliness becomes particularly significant in printers that are used in the retail space such a self-serve photo kiosks. In this application, the unintended spillage of toner can result in machine downtime and resulting loss of both revenue and customer satisfaction.

Typically, toner cartridges have a means to seal the cartridge such that the cartridges do not open or leak until the intended time. The use of a tape seal or door is a common means to achieve this. A disadvantage of these approaches is that the cartridge can be accidently opened during routine handling resulting in spillage. Some cartridge doors are designed such that a latching mechanism is used to prevent this accidental opening. Even in this case, the cartridge can be opened by a determined customer through manipulation of the latch, not realizing the spillage that will result.

A latch on a cartridge door that can only be opened with a key when outside the printer and is unlocked only through insertion into the printer equipped with the correct multiple keying features would solve the problem of accidental or deliberate opening of the cartridge where spillage could occur.

### SUMMARY OF THE INVENTION

Briefly, according to one aspect of the present invention a multiple locking feature on a cartridge door for a dry electrophotographic apparatus includes a cartridge wherein the cartridge contains a dry replenishment toner; a moveable door on the cartridge; multiple locking mechanism on the door for preventing accidental opening; and a key mechanism which unlocks the door when the cartridge is fully inserted into the electrophotographic apparatus.

It is the object of this invention to prevent the accidental or deliberate spillage of toner in an electrophotographic printer.

The invention and its objects and advantages will become more apparent in the detailed description of the preferred embodiment presented below.

### BRIEF DESCRIPTION OF THE DRAWINGS

FIG. 1 is a cross-sectional view of an electrophotographic printer.

FIG. 2 is a transverse cross-sectional view of a development system for an electrophotographic printer according to an embodiment of the present invention.

FIG. 3 is a longitudinal cross-sectional view of a development system for an electrophotographic printer according to an embodiment of the present invention.

FIG. 4 is a view of a toner cartridge and rail assembly.

FIG. 5 is a view of the toner cartridge door.

FIG. 6 is a view showing the locking features latched with the door closed.

FIG. 7 is a view of the door itself.

### DETAILED DESCRIPTION OF THE INVENTION

The present description will be directed in particular to elements forming part of, or in cooperation more directly with the apparatus in accordance with the present invention. It is to be understood that elements not specifically shown or described may take various forms well known to those skilled in the art.

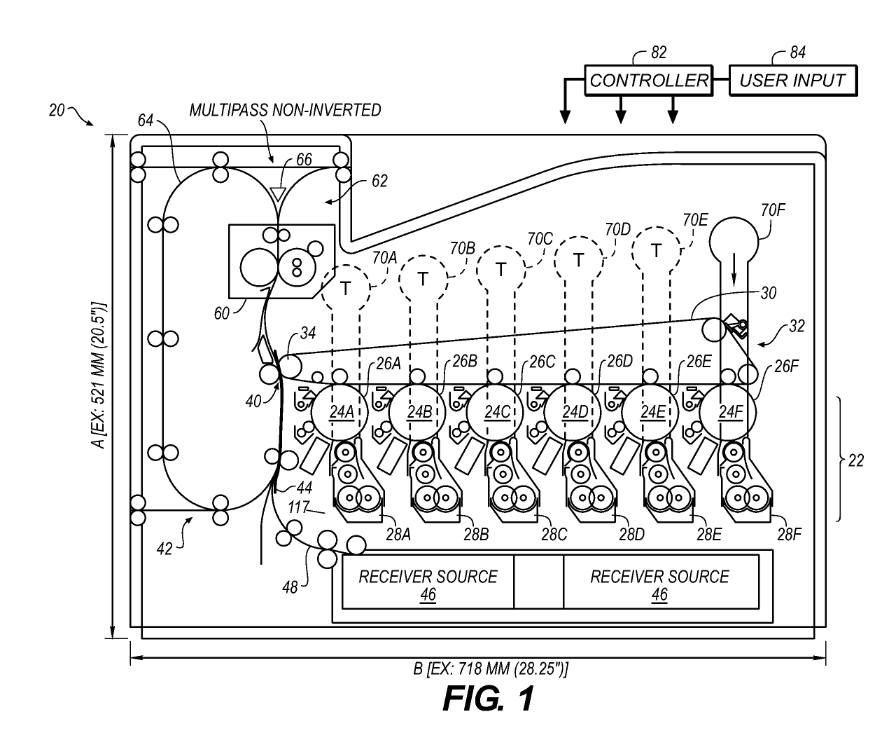

FIG. 1 shows an electrophotographic (EP) printer 20 having a print engine 22 for recording toner images on an intermediate transfer member (ITM) 30 and an intermediate transport system 32 with at least one intermediate transport motor 34 for moving ITM 30 past print engine 22 and to a transfer nip 40. Print engine forms a multi-toner image on intermediate transfer member 30 as ITM 30 is moved past print engine 22. A receiver transport system 42 moves a receiver 44 along a path 48 from a receiver source 46 through transfer nip 40 so the multi-toner image is transferred from ITM 30 to receiver 44. Receiver transport system 42 then moves receiver 44 and the transferred multi-toner image through a fuser 60 to fuse, fix, or sinter the transferred multi-toner image to receiver 44.

EP printer 20 is controlled by a printer controller 80 which can take the form of a microprocessor, microcontroller, or other such device and appropriate sensors of conventional design. EP printer 20 is shown having dimensions of A×B which are around in one example, 52×718 mm or less, however, it will be appreciated that such dimensions are exemplary and are not limiting.

As is shown in the embodiment of FIG. 1, print engine 22 has a plurality of electrophotographic modules 24A, 24B, 24C, 24D, 24E, and 24F that are provided in tandem and that transfer the various layers of toner necessary to form the multi-toner image. In this embodiment each electrophotographic module 24A, 24B, 24C, 24D, 24E, and 24F contains a single primary imaging member 26A, 26B, 26C, 26D, 26E, and 26F and a single development system 28A, 28B, 28C, 28D, 28E, and 28F to develop toner for ITM 30 or in other embodiments for a receiver 44.

Development stations 28A-28F provide charged toner for use in printing. Generally, toner takes the form of toner particles formed from a material or mixture of materials that can be charged and electrostatically propelled to form an image, pattern, or coating on an oppositely charged imaging member including a photoreceptor, photoconductor, electrostatically-charged, or magnetic surface. Toner is used in an electrophotographic print engine 22 to convert an electrostatic latent image into a visible image or pattern of toner on an ITM 30 and into a visible image on a receiver 44.

Toner particles can have a range of diameters, e.g. less than 8 μm, on the order of 10-15 μm, up to approximately 30 μm, or larger. When referring to particles of toner, the toner size or diameter is defined in terms of the median volume weighted diameter as measured by conventional diameter measuring devices such as a Coulter Multisizer, sold by Coulter, Inc. The volume weighted diameter is the sum of the mass of each toner particle multiplied by the diameter of a spherical particle of equal mass and density, divided by the total particle mass. Toner is also referred to in the art as marking particles or dry ink. In certain embodiments, toner can also comprise particles that are entrained in a wet carrier.

Color toner particles typically have optical densities such that a monolayer coverage (i.e. sufficient application of marking particles such that a microscopic examination would reveal a layer of marking particles covering between 60% and 100% of a primary imaging member) would have a transmission density of between 0.6 and 1.0 in the primarily absorbed light color (as measured using a device such as an X-Rite Densitometer with Status A filters). However, it will be appreciated that these transmission densities are exemplary only and that any conventional range for transmission density or reflectivity can be used with the color toner particles.

Toner can also include clear particles that have the appearance of being transparent or that while being generally transparent impart a coloration or opacity. Such clear toner can provide for example a protective layer on an image or can be used to create other effects and properties on the image.

The various electrophotographic modules each deliver only one type of toner and they can be used in various combinations as desired to print different types of images or to achieve other effects. In the electrophotographic engine shown in FIG. 1 six electrophotographic modules 24A, 24B, 24C, 24D, 24E and 24F enable six different types of toner to be applied in various combinations.

For example, in one application, electrophotographic modules 24A, 24B, 24C, 24D can supply toner particles of one of the four subtractive primary colors that can be applied in various combinations to create images having a full gamut of colors, thus creating an opportunity for fifth and sixth electrophotographic modules 24E and 24F can be used to deliver additional toner types. These additional toner types can include, but are not limited to toner particles that include different subtractive toner colors, clear toner, and raised print, MICR magnetic characters, as well as will specialty colors and metallic toners and can deliver toners that are not produced with the basic four subtractive color marking particles. In this example, fifth electrophotographic module 24E and sixth electrophotographic module 24F can deliver a clear toner in a first layer as an overcoat material and in a second layer to form raised textures above the overcoat layer. Here too, it will be understood that these examples are not limiting as fifth electrophotographic module 24E and sixth electrophotographic module 24F can delivery any known type of toner as may be useful or required. It will be appreciated that the organization of toner types with respect to particular electrophotographic modules 24A-24F is provided by way of example and is not limiting.

In particular, the selection of an individual operating or owning (hereafter referred to as the operator) EP printer 20 can provide control signals to controller 82 by way of a user input 84 that printer controller 82 can use to determine which specialty marking particles to apply to an image and where to apply these specially marking particles in order to achieve a particular print outcome. Similarly, input allowing printer controller 82 to determine which specialty marking strip like an image and where to apply these specially marking particles can be can take the form of signals from a user input system signals from a signals that are associated with a digital image provided for printing.

In the embodiment that is illustrated in FIG. 1, development systems 28A-28F develop the electrostatic latent image on a primary imaging member (PIM) 26A-26F respectively and thereby convert the electrostatic latent image a visible image. Each toner image is transferred, in register, to an intermediate transfer member (ITM) 30 to form a toner transfer image. Method and systems for imparting the charge pattern are well known to those of skill in the art. The ITM can be in the form of a continuous web as shown or can take other forms such as a drum or sheet. It is preferable to use a compliant intermediate transfer member, such as described in the literature, but noncompliant ITMs 30 can also be used.

The multi-toner image formed on ITM 30 is then transferred to a receiver 44 when receiver 44 passes through transfer nip 40 in conjunction with the multi-toner image. In the embodiment that is illustrated in FIG. 1, receiver 44 is provided in the form of receiver sheets that are held in the printer at receiver source 46. However, in other embodiments, receiver 44 can be provided on rolls or other forms.

Receiver 44 enters path 48 so as to travel initially in a counterclockwise direction through path 48. Alternatively, receiver 44 could also be manually input from the left side of the electrophotographic printer 20. The multi-toner image is transferred from the ITM to a receiver 44 and the image bearing receiver then passes through a fuser 60 where the image is fixed to the receiver.

The image then enters a region where the receiver either enters an inverter 62 or continues to travel counterclockwise through a recirculation path 64 that returns receiver 44 to receiver path 48 such that receiver 44 will pass through transfer nip 40 and fuser 62 again. If receiver 44 enters inverter 62, receiver 44 travels clockwise, stops, and then travels counterclockwise back through recirculation path 64 to receiver path 48. This inverts the image, thereby allowing the image to be duplexed. Prior to the inverter is a diverter 66 that can divert receiver 44 from inverter 62 and send receiver 44 along recirculation path 64 in a counterclockwise direction.

Recirculation of a non-inverted receiver 44 allows multiple passes of on a same side of receiver 44 as might be desired if multiple layers of marking particles are used in the image or if special effects such as raised letter printing using large clear toner are to be used. Operation of diverter 55 to enable a repeat of simplex and duplex printing can be visualized using the recirculation path 64.

It should be noted that, if desired, the fuser 60 can be disabled so as to allow a simplex image to pass through the fuser without fusing, if desired. This might be the case if an expanded color balance in simple printing is desired and a first fusing step might compromise color blending during the second pass through the EP engine. Alternatively, a fusing system 60 that merely tacks or sinters, rather than fully fuses, an image and is known in the literature can be used if desired such as when multiple simplex images are to be produced. The image can also be sent through a subsystem that imparts a high gloss to the image, as is known in the art.

### Development System

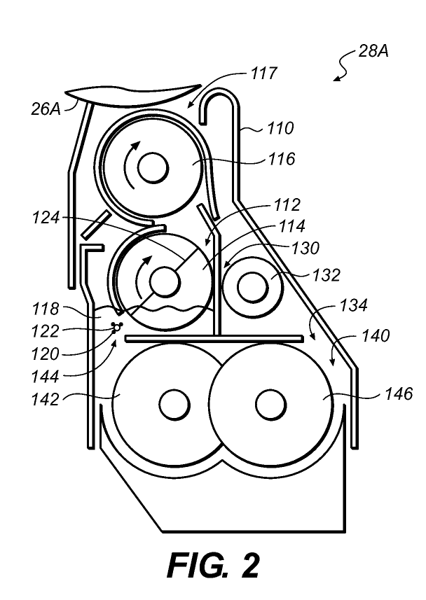

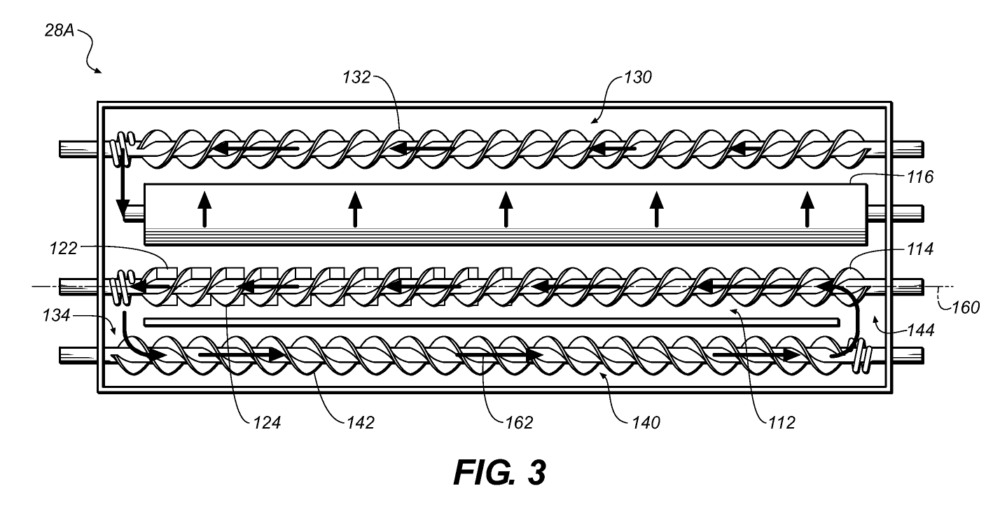

FIGS. 2 and 3 provide a first example embodiment of a development system 28A. FIG. 2 is a transverse cross-sectional view of development system 28A, while FIG. 3 is a longitudinal cross-sectional schematic view of one embodiment of development system 28A of FIG. 2 showing the directional flow of toner in development system 28A.

As is commonly understood in electrophotographic printers, development systems 28A-28F are used to create a supply of charged toner particles that can be exposed to an electrostatic field on a transfer medium or a receiver such that toner can be attracted to the receiver according to the intensity and pattern of the electrostatic image formed by the transfer medium or receiver. Charge is typically applied to such toner particles by a charging process in which toner particles are mixed with other particles in a manner that imparts a charge on the toner particles.

In this embodiment, development systems 28A-28F process two component developers such as those containing both toner particles and magnetic carrier particles. Accordingly, development systems 28A-28F of the type that can deliver two component developer using a rotating magnetic core, a rotating shell around a fixed magnetic core, or a rotating magnetic core, a rotating magnetic shell or a development roller to expose the toner and magnetic carrier to the image wise charged primary imaging member associated therewith. During this exposure, toner is drawn from the toner/carrier mix and onto the ITM 30. This toner must replaced at least to an extent necessary to provide a range of toner concentration in the mix that does not detract from the density or apparent density of the image that is formed on the intermediate.

It is therefore a function of development systems 28A-28F to replenish the toner in the developer after use to an extent that is sufficient to prevent the donor depletion artifacts from forming in an image. Replacement toner particles are added to the development systems 28A-28F by replenishment stations 70A-70F, each of which contains a toner type of the toner being used in development systems 28A-28F.

As is shown in FIG. 2, development system 28A comprises a housing 110 having a first channel 112 with a feed auger 114. A development roller 116 is adjacent feed auger 114 and is also adjacent an exposure window 117. The cross-sectional view of FIG. 2 shows a low volume of developer 118 containing magnetic particles and toner particles 120 (not to scale) in first channel 112. In FIG. 2, toner particles 120 are represented schematically as a filled-in circles and magnetic particles 122 as an unfilled circle. As is shown in the embodiment of FIG. 2, feed auger 114 optionally incorporates two of a plurality of paddles 124 to facilitate toner movement which can be used to facilitate toner movement as will be described in general in greater detail below.

In operation, developer 118 is fed from first channel 112 to development roller 116. Development roller 116 moves developer 118 to exposure window 117 where developer 118 is positioned in proximity with primary imaging member 26A. A portion of toner 120 in developer 118 exposed to development roller 116 is transferred onto primary imaging member 26A as a product of electrostatic attraction caused by electrostatic patterns applied to primary imaging member 26A by a writer (not shown) of conventional design. After exposure, the used developer and any toner remaining therein is moved by developer roller 118 away from exposure window 117 and drops into second channel 130. A second auger 132 is in second channel 130 to collect any toner particles 120 that enters second channel 130 and to direct developer 118 to an opening 134 at the rear of housing 110 where toner particles 120 collected by second channel 130 is dropped into third channel 140. At least one mixing auger 142 is provided in third channel 140 to move developer 118 to a passageway 144 at the front of housing 110, where this developer 118 is fed to feed auger 114 in first channel 112. As is illustrated here, mixing auger 142 is optionally assisted by a second mixing auger 146.

FIG. 3 is a longitudinal cross-sectional schematic view of the development system 28A of FIG. 2 illustrating developer flow in development system 28A. As is shown in FIG. 3, there is a decreasing volume of toner particles 120 in first channel 112 along an axis 160 of feed auger 114. In FIG. 3 this is indicated by the decreasing length of the arrows 162 in the direction of developer flow indicated by the arrow direction. Uniform flow of developer 118 over development roller 116 is indicated by similar arrows of the same size. Increasing volume of developer 118 in second channel 132 is indicated by the increasing length of the arrows in the direction of developer flow. The arrows also indicate that developer 118 from first channel 112 and second channel 130 is collected in the third channel 140, where this developer 118 is mixed with additional toner from toner sources 70A and fed to first channel 112.

### Toner Cartridge

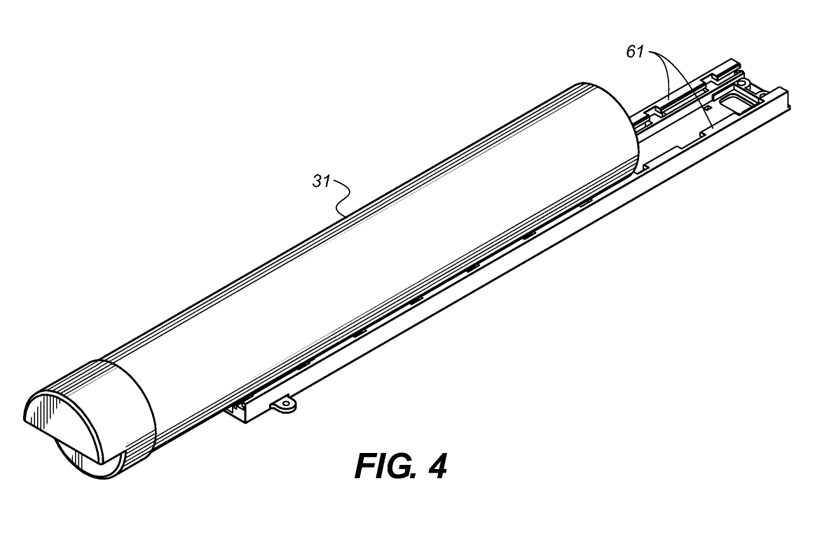

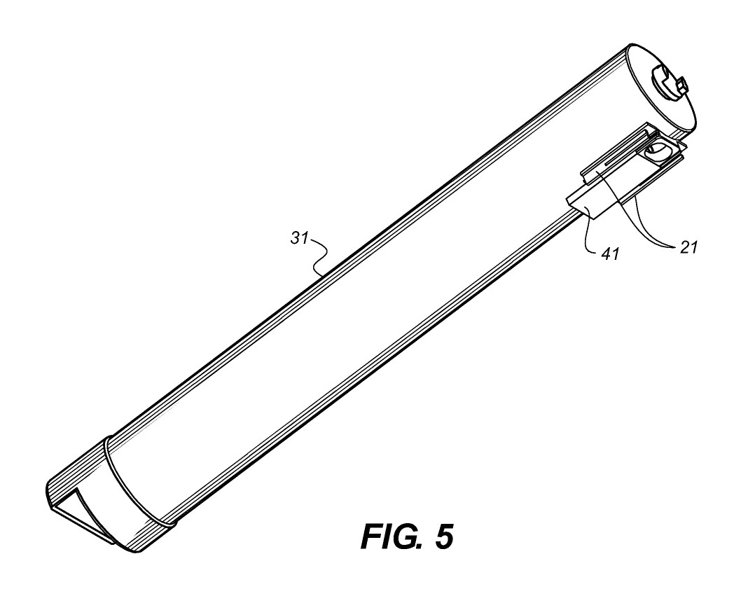

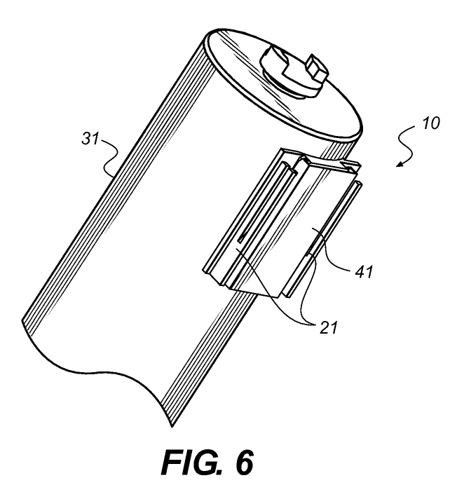

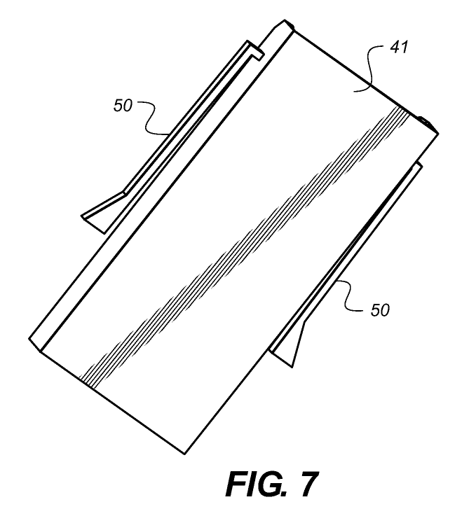

Referring now to FIG. 6, a system comprising multiple locking features 10 on a cartridge door 21 for a dry electrophotographic apparatus. In FIG. 5, a toner cartridge 31 containing dry replenishment toner a moveable door 41 shown open on the cartridge and in FIG. 7 in greater detail the multiple locking mechanism on the door 50 for preventing accidental opening. In FIG. 4 a multiple key mechanism 61 is shown which unlocks both sides of the door simultaneously when the cartridge is fully inserted into an electrophotographic printer. The key mechanism 61 in FIG. 4 are shown to be of different widths but could also be unique in shape to prevent the unintended opening of the door if for example the incorrect color were to be inserted into the printer. In other embodiments of the design, the multiple locking features can be in the form of tumblers, spring loaded, or pin tumblers.

The invention has been described in detail with particular reference to certain preferred embodiments thereof, but it will be understood that variations and modifications can be effected within the scope of the invention.

### PARTS LIST

10 system with multiple locking features
20 electrophotographic (EP) printer
21 cartridge door
22 print engine
24A-24F electrophotographic module
26A-26F primary imaging member (PIM)
28A-28F development system
30 intermediate transfer member (ITM)
31 toner cartridge
32 intermediate transport system
34 intermediate transport motor
40 transfer nip
41 moveable door
42 receiver transport system
44 receiver
46 receiver source
48 receiver path
50 multiple locking features
60 fuser
61 key mechanism
62 inverter
64 recirculation path
66 diverter
70A-70F replenishment stations
80 print controller
82 controller
84 user input
110 housing
112 first channel
114 feed auger
116 development roller
117 exposure window
118 developer
120 toner particles
122 magnetic particles
124 paddles
130 second channel
132 second auger
134 opening
140 third channel
142 mixing auger
144 passageway
146 second mixing auger
160 axis
162 arrows

1. A multiple locking feature on a cartridge door for a dry electrophotographic apparatus comprising:
a cartridge wherein the cartridge contains a dry replenishment toner;
a moveable door on the cartridge;
multiple locking mechanism on the door for preventing accidental opening; and
a key mechanism which unlocks the door when the cartridge is fully inserted into the electrophotographic apparatus.

2. The multiple locking feature of claim 1 wherein the key mechanism unlocks both sides of the door.

3. The multiple locking feature of claim 2 wherein both sides are unlocked simultaneously.

4. The multiple locking feature of claim 1 wherein the multiple locking mechanism comprises shaped keyways.

5. The multiple locking feature of claim 1 wherein the multiple locking mechanism are different for each color toner of the electrophotographic apparatus.

6. The multiple locking feature of claim 1 wherein the multiple locking mechanism are differently shaped tabs.

7. The multiple locking feature of claim 1 wherein the multiple locking mechanisms are spring loaded tumblers or pin tumblers.
